(19) United States
(12) Patent Application Publication
(10) Pub. No.: US 2024/0352916 A1
(43) Pub. Date: Oct. 24, 2024

(54) STABILITY COMPONENT, USE OF A STABILITY COMPONENT, WIND TURBINE BLADE AND METHODS OF MANUFACTURING A WIND TURBINE BLADE

(71) Applicant: Siemens Gamesa Renewable Energy Innovation & Technology, S. L., Sarriguren (DK)

(72) Inventor: Javier Yuste Soler, Burlada (ES)

(21) Appl. No.: 18/635,179

(22) Filed: Apr. 15, 2024

(30) Foreign Application Priority Data
Apr. 21, 2023 (EP) 23382376.4

(51) Int. Cl. F03D 1/06

(52) U.S. Cl. CPC F03D 1/0675; F05B 2240/304

(57) ABSTRACT

A stability component configured to be arranged in an inner space of a wind turbine blade is provided, a use of a stability component for stabilizing a blade shell of a wind turbine blade of a wind turbine, a wind turbine blade and methods of manufacturing a wind turbine blade.

### CROSS-REFERENCE TO RELATED APPLICATIONS

This application claims priority to EP application Ser. No. 23/382,376.4, having a filing date of Apr. 21, 2023, the entire contents of which are hereby incorporated by reference.

### FIELD OF TECHNOLOGY

The following relates to a stability component, a use of a stability component, a wind turbine blade and methods of manufacturing a wind turbine blade.

### BACKGROUND

The internal structure of a wind turbine blade can comprise shells (suction and pressure shells), which are light elements in charge of maintaining a proper aerodynamic shape. Furthermore, the internal structure of the wind turbine blade can comprise, as an element, a main beam, which is the main load carrying element and is running in a longitudinal direction of the wind turbine blade. The main beam can be formed by the main spar caps, which are responsible for carrying the main longitudinal load, and the main shear web, which is responsible for carrying the main shear load. Furthermore, the internal structure of the wind turbine blade can comprise, as an element, a trailing-edge beam, which is an element running in a longitudinal direction of the wind turbine blade and is placed in between the main beam and a trailing edge of the wind turbine blade. The trailing-edge beam is used basically for shell stability at the zones where shell panels are big, although it is also carrying a small but relevant percentage of the longitudinal and shear loads of the wind turbine blade. The trailing-edge beam can be formed by secondary spar caps and a secondary shear web.

Disadvantageously, the trailing-edge beam is a non-efficient element in terms of added mass (or cost) versus structural performance. Often, it is placed at a zone with reduced profile thickness, so it cannot be efficient in providing flapwise bending stiffness. Furthermore, often, it is placed distanced to the very trailing-edge position, but closer to the main beam, so it will not be efficient in providing edge-wise bending stiffness either.

### SUMMARY

An aspect relates to a simple and/or inexpensive and/or lightweight and/or stable stability component respectively wind turbine blade. It further relates to a simple and/or inexpensive method of manufacturing a wind turbine blade.

Features and details described in connection with the stability component according to embodiments of the invention naturally also apply in connection with the use of a stability component according to embodiments of the invention and/or the wind turbine blade according to embodiments of the invention and/or the method of manufacturing according to the embodiments of the invention and vice versa in each case, so that reference is or can always be made mutually with respect to the disclosure of the individual aspects of embodiments of the invention.

According to a first aspect, embodiments of the present invention disclose a stability component, wherein the stability component is configured to be arranged in an inner space of a wind turbine blade angled to a longitudinal direction of the wind turbine blade by a component interface of the stability component for stabilizing a blade shell of the wind turbine blade of a wind turbine. Furthermore, the component interface of the stability component is built respectively formed at least partially on an edge section of the stability component. Furthermore, the stability component is multi-part with at least a first sub-body and a second sub-body, wherein the first sub-body and/or the second sub-body is respectively formed plate-like, and wherein at least the first sub-body is arrangeable or arranged with an arrangement section on a counter arrangement section of the second sub-body to increase the stability of the stability component.

In embodiments, the edge section of the stability component is a section of the stability component at the edge, especially at an outer edge, of the stability component and/or at the edge, especially an outer edge, of the first sub-body and/or the edge, especially an outer edge, of the second sub-body. The edge section can also be understood as an outer edge section. In an embodiment, the component interface of the stability component is built respectively formed circumferentially on the edge section, especially on an outer edges section, of the stability component respectively the first sub-body respectively the second sub-body. Thus, the blade shell can be stabilized in a particularly advantageous way.

In embodiments, it is conceivable that the stability component and/or the first sub-body and/or the second sub-body is arranged, for example directly arranged, to the blade shell or to a blade shell laminate of the blade shell or to a sandwich shell laminate of the blade shell of the wind turbine blade by the component interface of the stability component. In embodiments, it is conceivable that the first sub-body and/or the second sub-body of the stability component is respectively integrally formed with the blade shell of the wind turbine blade. Thus, the stability component can be particularly stable.

In embodiments, the arrangement of the stability component and/or the first sub-body and/or the second sub-body to the blade shell is a materially bonded arrangement, e.g., with the help of a resin and/or an adhesive. Thus, the arrangement of the stability component can be done in a simple manner. Furthermore, the wind turbine blade can be particularly lightweight.

In embodiments, it is conceivable that at least the first sub-body and the second sub-body are comprising, or are made of, the same material(s) and/or that at least the first sub-body and the second sub-body are comprising the same (material) structure. Thus, the stability component can be fabricated in a simple and/or cost-effective manner.

In embodiments, the first sub-body is following (at least partially or completely) the (inner) blade shell shape of the blade shell of the wind turbine blade for stabilizing the blade shell and/or the second sub-body is following (at least partially or completely) the (inner) blade shell shape of the blade shell of the wind turbine blade for stabilizing the blade shell.

With the stability component, the blade shell can be stabilized in a simple and/or inexpensive manner. Furthermore, a buckling performance of the wind turbine blade can be particularly advantageous, especially improved with regard to a wind turbine blade comprising a trailing-edge beam. Furthermore, an adhesive joint at the trailing edge of the wind turbine blade can be particularly stable so that also the wind turbine blade can be particularly stable. Thus, advantageously, a trailing-edge beam can be dispensed with, and a mass of the wind turbine blade can be particularly small, especially reduced with regard to a wind turbine blade comprising a trailing-edge beam.

It may be advantageous if the first sub-body of the stability component is frame-shaped to form a circumferential stabilizing frame, wherein the circumferential stabilizing frame is surrounding a frame opening. The frame-shaped first sub-body of the stability component can form a triangle-like stabilizing frame, wherein the triangle-like stabilizing frame is surrounding the frame opening, for example a triangle-like frame opening. The stabilizing frame, especially the triangle-like stabilizing frame, enables that on the one hand, the blade shell of the wind turbine blade can be particularly advantageous circumferentially stabilized from a main beam of the wind turbine blade to a trailing edge of the wind turbine blade. On the other hand, the frame opening allows enough space for placing at least one mandrel or multiple mandrels in an inner space of arranged components for integrally manufacturing a blade shell of the wind turbine blade, wherein after casting, the mandrels can be removed, and the frame opening can be at least partially closed by the second sub-body to increase the stability of the stability component. In embodiments, a frame thickness of the frame-shaped first sub-body along the first sub-body is equal or substantially equal. Thus, the stability of the stability component can be particularly advantageous. In embodiments, the second sub-body fills respectively covers the whole frame opening of the circumferential stabilizing frame, wherein especially the second sub-body is overlapping an inner edge of the first sub-body. Thus, the stability component is particularly stable.

It may be advantageous if the second sub-body can be arranged or is arranged with the counter arrangement section on the arrangement section of the first sub-body in such a way that the frame opening is at least partially covered respectively closed by the second sub-body in order to increase a stability of the stability component. Thus, the stability component can stabilize the blade shell of the wind turbine blade particularly advantageous. In an embodiment, the second sub-body is plate-like, especially a plate-like sandwich-body. Thus, the second sub-body can be manufactured particularly easily and/or inexpensively and/or lightweight. As already mentioned, the second sub-body closes respectively covers the whole frame opening of the circumferential stabilizing frame, wherein especially the second sub-body is overlapping an inner edge of the first sub-body. Thus, the stability component is particularly stable, and the blade shell of the wind turbine blade is stabilized in particularly advantageous way.

It may be advantageous in embodiments if the stability component comprises a stabilizing frame, in particular a circumferential stabilizing frame, wherein the first sub-body is forming together with the second sub-body at least a part of the stabilizing frame, wherein the stabilizing frame is surrounding a frame opening. In other words, the stabilizing frame can be a multi-part stabilizing frame comprising several or multiple frame parts, wherein the several or multiple frame parts (at least the first sub-body and the second sub-body) are forming the stabilizing frame. Thus, the stability component comprises several or multiple frame parts (at least the first sub-body and the second sub-body) for forming the stabilizing frame, e.g., a triangle-like stabilizing frame, with a frame opening, wherein especially the stability component can comprise at least a third sub-body to close respectively to cover the frame opening, for example to close respectively to cover the whole frame opening, of the stabilizing frame, especially circumferential stabilizing frame. It is also conceivable that the stabilizing frame is a non-continuous stabilizing frame, wherein especially at least some frame parts a spaced apart. Due to the multi-part design, the stability component can be arranged particularly easily in an inner space.

It may be advantageous if the first sub-body with the arrangement section is arranged detachably, in particular non-destructively detachably, on the counter arrangement section of the second sub-body. Thus, inner access to the wind turbine blade, in case it is needed, can be guaranteed. The detachable, in particular the non-destructively detachable, arrangement can be a force-locking and/or a form-fit arrangement respectively connection, e.g., a bolt connection. Alternatively, it is also conceivable that the first sub-body with the arrangement section is arranged non-detachably on the counter arrangement section of the second sub-body, e.g., by an adhesive. Thus, the stability component can be particularly simple in design.

It may be advantageous if the first sub-body comprises a plate-shaped core-body having a first plate side and a second plate side opposite the first plate side, and/or a first cover-body for absorbing forces to stabilize the blade shell of the wind turbine blade, wherein the first cover-body is arranged on the first plate side of the core-body, and/or a second cover-body for absorbing forces to stabilize the blade shell of the wind turbine blade, wherein the second cover-body is arranged on the second plate side of the core-body. Alternatively or additionally, it may be advantageous if the second sub-body comprises a plate-shaped core-body having a first plate side and a second plate side opposite the first plate side, and/or a first cover-body for absorbing forces to stabilize the blade shell of the wind turbine blade, wherein the first cover-body is arranged on the first plate side of the core-body, and/or a second cover-body for absorbing forces to stabilize the blade shell of the wind turbine blade, wherein the second cover-body is arranged on the second plate side of the core-body. Thus, the first sub-body and/or the second sub-body of the stability component can have a particularly easy structure. In embodiments, at least the core-body, the first cover-body and the second cover-body can form a sandwich-body, especially a laminated sandwich-body. In other words, the core-body, the first cover-body and the second cover-body can form a sandwich laminate. The following features and/or details and/or advantages and/or statements regarding the core-body and/or the first cover-body and/or the second cover-body may apply to the first sub-body, the second sub-body, further sub-bodies and/or the stability component and/or the first stability component and/or further stability components with a core-body and/or with a first cover-body and/or with a second cover-body itself. In embodiments, the thickness of the core-body is greater than the thickness of the first cover-body and/or the thickness of the core-body is greater than the thickness of the second cover-body. For example, the core-body comprises foam and/or wood, e.g., balsa wood, and/or the first cover-body comprises fibers, e.g., glass fibers respectively glass plies and/or carbon fibers respectively carbon plies, and/or the second cover-body comprises fibers, e.g., glass fibers respectively glass plies and/or carbon fibers respectively carbon plies. It is conceivable that the fibers of the first cover-body and/or the fibers of the second cover-body are aligned non-unidirectional. Thus, the stability component can carry the loads in a particularly advantageous way and the stability of the stability component can be particularly advantageous. Furthermore, it is conceivable that the first cover-body is layer-like and the second cover-body is layer-like.

According to a second aspect, embodiments of the present invention show a use of at least a first stability component for stabilizing a blade shell of a wind turbine blade of a wind turbine by arranging the at least one first stability component in an inner space of the wind turbine blade angled to a longitudinal direction of the wind turbine blade at least in a middle region of the wind turbine blade (especially comprising a maximum chordal width of the wind turbine blade) by a component interface of the at least one first stability component. Furthermore, the at least one first stability component is plate-shaped.

Features and/or details and/or advantages and/or statements regarding the stability component and/or the first stability component and/or the second stability component and/or further stability components may apply to the stability component and/or to the first stability component and/or to the second stability component and/or to further stability components, and vice versa.

In embodiments, the middle region of the wind turbine blade comprises a maximum chordal width of the wind turbine blade. The maximum chordal width is the maximum distance between the leading edge and the trailing edge of the wind turbine blade. Furthermore, in embodiments, the middle region extends along the longitudinal axis of the wind turbine blade around, especially uniformly around, the maximum chordal width. In embodiments, the middle region of the wind turbine blade can comprise about 10-50 m, especially 20-40 m, of the longitudinal length of the wind turbine blade, for example around, especially uniformly around, the maximum chordal width of the wind turbine blade.

The longitudinal direction of the wind turbine blade can be understood also as the longitudinal axis of the wind turbine blade.

It is conceivable for forming the plate-shaped first stability component that the at least one first stability component comprises a plate-shaped core-body having a first plate side and a second plate side opposite the first plate side, a first cover-body for absorbing forces to stabilize the blade shell of the wind turbine blade, wherein the first cover-body is arranged on the first plate side of the core-body and a second cover-body for absorbing forces to stabilize the blade shell of the wind turbine blade, wherein the second cover-body is arranged on the second plate side of the core-body. Thus, the at least one stability component can be particularly simple.

In embodiments, the first at least one stability component can be a one-piece stability component. With the plate-shaped and/or sandwich-like one-piece first stability component, the blade shell can be stabilized in a simple and/or inexpensive manner. Furthermore, a buckling performance of the wind turbine blade can be particularly advantageous. Furthermore, an adhesive joint at the trailing edge of the wind turbine blade can be particularly stable so that also the wind turbine blade can be particularly stable. Thus, advantageously, a trailing-edge beam can be dispensed with.

It may be advantageous in embodiments if the wind turbine blade comprises a main beam, in particular a single main beam, extending in the longitudinal direction of the wind turbine blade with two opposite arranged spar caps and a web connecting the two spar caps, wherein the at least one first stability component is at least partially arranged on the main beam and the blade shell, and wherein the at least one first stability component extends from the main beam in a direction towards a trailing edge of the wind turbine blade in the inner space of the wind turbine blade, especially from the main beam to a trailing edge of the wind turbine blade in the inner space of the wind turbine blade or close to it. It is conceivable that the at least one first stability component is not reaching the trailing edge, especially a trailing edge vertical wall. In other words, the at least one first stability component can end slightly before the trailing edge, especially slightly before a trailing edge vertical wall. With the plate-shaped first stability component, the blade shell can be stabilized in a simple and/or inexpensive manner. In embodiments, the plate-shaped first stability component can be understood also as a rib. In embodiments, the at least one first stability component is placed covering a zone from the main beam to the trailing edge of the wind turbine blade. Thus, especially there is no need to also incorporate a stability component at the leading edge of the wind turbine blade. Furthermore, advantageously, a trailing-edge beam can be dispensed with. Thus, a single main beam can be used. In embodiments, the main beam is the main load carrying element, which is for example placed close to the position of profile maximum thickness. Furthermore, especially the two spar caps of the main beam are facing each other. A spar cap is responsible for carrying the main longitudinal load. Furthermore, the main beam comprises a web, especially a main shear web, which is responsible for carrying the main shear load. Furthermore, in embodiments, the arrangement of the at least one first stability component to the blade shell and/or the main beam is a materially bonded arrangement, e.g., with the help of a resin and/or an adhesive. Thus, the arrangement of the at least one first stability component can be done in a simple manner. Furthermore, in embodiments, the at least one first stability component is shaped in such a way that it follows (at least partially or completely) the (inner) blade shell shape of the blade shell of the wind turbine blade and/or that it follows (at least partially or completely) the main beam shape of the main beam of the wind turbine blade, wherein especially the first stability extends from the main beam to a trailing edge of the wind turbine. In embodiments, the at least one first stability component fills respectively covers (at least sectionwise in the longitudinal direction of the wind turbine blade) the whole opening, which is built from the main beam to the trailing edge of the wind turbine blade. Thus, the blade shell of the wind turbine blade can be particularly advantageously stabilized.

It may be advantageous if the at least one first stability component is arranged in the inner space of the wind turbine blade at an angle of 90° or substantially 90° with regard to the longitudinal direction of the wind turbine blade, and wherein especially the at least one first stability component extends from the main beam to a trailing edge of the wind turbine blade in the inner space of the wind turbine blade. In other words, the at least one first stability component can be a transversal arranged with regard to the longitudinal direction of the wind turbine blade. Thus, the first stability does not have to take an important share of a longitudinal load, and therefore the at least one first stability component can be particularly simply designed and/or inexpensive.

Alternatively, it may be advantageous if the at least one first stability component is arranged in the inner space of the wind turbine blade at an angle of 45°-85°, in particular at an angle of 60°-80°, with regard to the longitudinal direction of the wind turbine blade. Thus, the first stability can also take at least a small share of a longitudinal load.

It may be advantageous if at least one second plate-shaped stability component is arranged in the inner space of the wind turbine blade angled to the longitudinal direction of the wind turbine blade in the middle region of the wind turbine blade by a component interface of the at least one second stability component for stabilizing the blade shell of the wind turbine blade of the wind turbine, wherein the at least one first stability component is spaced apart from the at least one second stability component in the longitudinal direction of the wind turbine blade. Thus, the blade shell can be stabilized in a particularly simple and/or inexpensive manner. In an embodiment, the at least one first stability component is placed at the position of the maximum chordal width of the wind turbine blade, wherein especially the at least one second stability component is placed spaced apart from the at least one first stability component in the longitudinal direction of the wind turbine blade either in a direction towards a root attachment interface of the wind turbine blade or towards a wind turbine blade tip of the wind turbine blade. Furthermore, in embodiments, the distance between two arranged stability components, e.g., the at least one first and the at least one second stability component, according embodiments of the invention can be around 1-6 m(eters), especially 2-5 m. It is also conceivable that three or more stability components according to embodiments of the invention are used for stabilizing the blade shell of the wind turbine blade, wherein especially the three or more stability components are spaced apart, for example evenly spaced apart, from each other, wherein especially the at least one first stability component is placed at the position of the maximum chordal width of the wind turbine blade. Thus, the blade shell can be particularly stabilized. In an embodiment, at least the at least one first stability component and the at least one second stability component are arranged in the inner space of the wind turbine blade such that they have the same or substantially the same angle to the longitudinal direction respectively axis of the wind turbine blade.

It may be advantageous if at least the at least one first stability component is configured according to embodiments of the invention and/or the at least one second stability component is configured according to embodiments of the invention, especially according to the first aspect of embodiments of the invention.

The use of the at least one first stability component according to the second aspect of embodiments of the invention thus exhibits the same advantages as have already been described with respect to the stability component according to the first aspect of embodiments of the invention.

According to a third aspect, embodiments of the present invention disclose a wind turbine blade for a wind turbine, the wind turbine blade extending in a longitudinal direction from a root region comprising a root attachment interface for attaching the wind turbine blade to a rotor of the wind turbine, through a middle region comprising a maximum chordal width of the wind turbine blade, into a tip region comprising a wind turbine blade tip. Furthermore, the wind turbine blade comprises a blade shell, wherein the blade shell is surrounding an inner space of the wind turbine blade. Furthermore, the wind turbine blade comprises a main beam, in particular a single main beam, running in the longitudinal direction of the wind turbine blade with two opposite arranged spar caps and a web connecting the two spar caps. Furthermore, the wind turbine blade comprises at least a stability component, wherein the stability component is configured according to embodiments of the invention. Furthermore, the stability component is arranged by a component interface of the stability component in the inner space of the wind turbine blade angled to the longitudinal direction of the wind turbine blade for stabilizing the blade shell of the wind turbine blade of the wind turbine, wherein the component interface of the stability component is built respectively formed at least partially on an edge section of the stability component and wherein especially the stability component is at least partially arranged on the main beam and/or the blade shell. Furthermore, the stability component extends from the main beam in a direction towards a trailing edge of the wind turbine blade in the inner space of the wind turbine blade, especially from the main beam to a trailing edge of the wind turbine blade in the inner space of the wind turbine blade or close to it. It is conceivable that the stability component is not reaching the trailing edge, especially a trailing edge vertical wall. In other words, the stability component can end slightly before the trailing edge, especially slightly before a trailing edge vertical wall.

In embodiments, the root region of the wind turbine blade is a region starting from the root attachment interface for attaching the wind turbine blade to the rotor of the wind turbine and ending at a beginning of the middle region of the wind turbine blade.

In embodiments, the tip region of the wind turbine blade is a region starting from an ending of the middle region of the wind turbine blade and ending at the wind turbine blade tip.

It is conceivable that the blade shell is produced as a laminate, especially a sandwich laminate, wherein especially the laminated blade shell comprises at least a plate-shaped core-body having a first plate side and a second plate side opposite the first plate side, and/or a first cover-body for absorbing forces, wherein the first cover-body is arranged on the first plate side of the core-body, and/or a second cover-body for absorbing forces, wherein the second cover-body is arranged on the second plate side of the core-body. In embodiments, the thickness of the core-body is greater than the thickness of the first cover-body and/or the thickness of the core-body is greater than the thickness of the second cover-body. For example, the core-body comprises foam and/or wood, e.g., balsa wood, and/or the first cover-body comprises fibers, e.g., glass fibers respectively glass plies and/or carbon fibers respectively carbon plies, and/or the second cover-body comprises fibers, e.g., glass fibers respectively glass plies and/or carbon fibers respectively carbon plies.

In embodiments, it is conceivable that the stability component is arranged, for example directly arranged, to the blade shell or to a blade shell laminate of the blade shell or to a sandwich shell laminate of the blade shell of the wind turbine blade by the component interface of the stability component.

It may be advantageous if at least several or a plurality of stability components are arranged by a respective component interface in the middle region in the inner space of the wind turbine blade each angled to the longitudinal direction of the wind turbine blade so that the blade shell of the wind turbine blade of the wind turbine is stabilized, wherein the several or the plurality of stability components are arranged spaced apart from each other in the longitudinal direction of the wind turbine blade. Thus, the blade shell of the wind turbine blade can be particularly stabilized in the longitudinal direction of the wind turbine blade. In embodiments, each of the several or plurality of the stability components is configured according to the invention, especially according to a first and/or second aspect of the embodiments of the invention. In an embodiment, each of the several or the plurality of stability components is shaped in such a way that it follows the inner blade shell shape of the blade shell of the wind turbine blade and/or that it follows the main beam shape of the main beam of the wind turbine blade so that each of the stability components is extending from the main beam to a trailing edge of the wind turbine. Thus, the blade shell of the wind turbine blade can be particularly stabilized at least in the middle region of the wind turbine blade.

The wind turbine blade according to the third aspect of embodiments of the invention thus exhibits the same advantages as have already been described with respect to the stability component according to the first aspect of embodiments of the invention and/or the use of the at least one first stability component according to the second aspect of embodiments of the invention.

According to further aspects, embodiments of the present invention disclose methods of manufacturing a wind turbine blade.

According to an aspect, embodiments of the present invention disclose a method of manufacturing a wind turbine blade for a wind turbine, wherein in particular, the wind turbine blade is configured according to embodiments of the invention. In embodiments, the method comprises as a step that several or multiple blade shell members, e.g., two blade shell halves, of a blade shell of the wind turbine blade are provided. Furthermore, in embodiments the method comprises as a step that at least a stability component is provided, wherein the stability component is configured according to embodiments of the invention. Furthermore, in embodiments the method comprises as a step that the at least one stability component is arranged or arranged and joined to at least a first blade shell member of the several or the plurality of blade shell members, wherein especially the at least one first blade shell member is additionally arranged to a component of a main beam of the wind turbine blade, e.g., to a spar cap and/or a web. Furthermore, in embodiments the method comprises as a step that the remaining blade shell members of the several or the plurality of blade shell members are arranged to the first blade shell member and to the stability component, which is arranged to the first blade shell member. Furthermore, in embodiments the method comprises as a step that at least the several or the plurality of blade shell members and the at least one stability component are joined, in particular are non-detachably joined.

The process steps described to this method before and, in the following, can be carried out, if technically reasonable, individually, together, singly, multiply, temporally parallel and/or successively in any order.

In embodiments, the arranging of the at least one stability component to the first blade shell member of the several or the plurality of blade shell members is a material bonded arranging, e.g., with the help of a resin and/or an adhesive. Thus, the arrangement of the stability component can be done in a simple manner.

According to an aspect, embodiments of the present invention disclose a method of manufacturing a wind turbine blade for a wind turbine, wherein at least a blade shell of the wind turbine blade is integrally manufactured, and wherein in particular the wind turbine blade is configured according to embodiments of the invention. In embodiments, the method comprises as a step that at least a stability component is provided, wherein the stability component is configured according to the invention, especially according to the first aspect of embodiments of the invention. Furthermore, in embodiments the method comprises as a step that (provided) components to integrally form the blade shell of the wind turbine blade are arranged, wherein the arranged components are forming an inner space. Furthermore, in embodiments the method comprises as a step that at least the first sub-body of the stability component is arranged in the inner space formed by the arranged components. Furthermore, the method comprises as a step that the first sub-body of the stability component is joined to the components. Furthermore, in embodiments the method comprises as a step that at least the components to form the integrally manufactured blade shell are joined, in particular are non-detachably joined. Furthermore, in embodiments the method comprises as a step that the second sub-body with the counter arrangement section is arranged to the arrangement section of the first sub-body to increase a stability of the stability component, wherein especially the second sub-body is arranged to the first sub-body temporally after joining, in particular non-detachably joining, the components to form the integrally manufactured blade shell.

In embodiments, the provided components to integrally form the blade shell of the wind turbine blade can be core-bodies, e.g., balsa wood, and/or cover-bodies, e.g., fiber layers respectively fiber plies, and/or resin and/or adhesive and so on.

A desired sequence of steps provides that in a first step, components to integrally form the blade shell of the wind turbine blade are provided and that at least one stability component or several stability components are provided, wherein for manufacturing the integrally blade shell the stability component(s) is (are) configured according to the first aspect of embodiments of the invention. In a second step, the provided components for integrally forming the blade shell are arranged in such a way that an inner space, e.g., by help of mandrels, is formed. Afterwards, at least the first sub-body of the at least one stability component is arranged in the inner space at a designated position. In a following step, the first sub-body of the at least one stability component is joined, e.g., by material bonded arrangement and/or a force-locking arrangement and/or a form-fitting arrangement, with the provided components, which are forming the integrally manufactured blade shell, and/or the components to form the integrally manufactured blade shell are joined together, e.g., by a vacuum infusion process with the help of a resin. After curing of the resin, e.g., an epoxy resin, mandrels arranged in the inner space of the blade shell can be removed particularly easy, for example via a frame opening formed by the first sub-body of the at least one stability component, at an ending (root and/or tip) of the integrally manufactured blade shell. In a following step, the second sub-body is arranged, especially non-detachably arranged, with the counter arrangement section to the arrangement section of the first sub-body to increase a stability of the stability component.

The process steps described to this method before and in the following, can be carried out, if technically reasonable, individually, together, singly, multiply, temporally parallel and/or successively in any order.

In embodiments, the method according to the further aspects of the invention thus exhibit the same advantages as have already been described with respect to the stability component according to the first aspect of embodiments of the invention and/or the use of the least one first stability component according to the second aspect of embodiments of the invention and/or the wind turbine blade according to the third aspect of the embodiments of the invention and/or the further method according to embodiments of the invention.

According to a further aspect, embodiments of the present invention disclose a wind turbine, wherein the wind turbine comprises a wind turbine blade, wherein the wind turbine blade is configured according to embodiments of the invention and/or the wind turbine blade is manufactured according to a method according to embodiments of the invention.

The wind turbine according to the further aspect of embodiments of the invention thus exhibits the same advantages as have already been described with respect to the mentioned aspects of embodiments of the invention.

Further measures improving embodiments of the invention result from the following description of some examples of implementation of embodiments of the invention, which are shown schematically in the figures. All features and/or advantages arising from the claims, the description or the drawings, including constructional details, spatial arrangements and process steps, may be essential to embodiments of the invention both individually and in the various combinations. It should be noted that the figures are descriptive only and are not intended to limit embodiments of the invention in any way.

### BRIEF DESCRIPTION

Some of the embodiments will be described in detail, with references to the following Figures, wherein like designations denote like members, wherein:

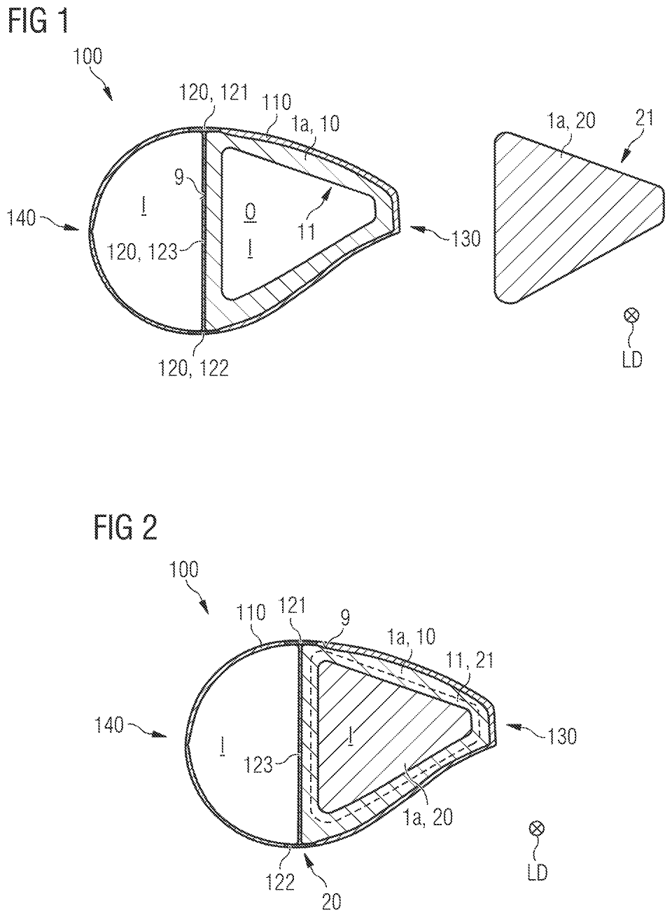

FIG. 1 depicts a wind turbine blade with a stability component;

FIG. 2 depicts a wind turbine blade with a stability component;

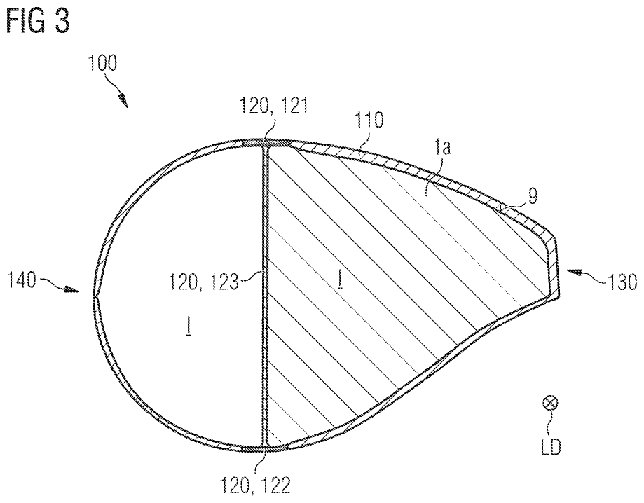

FIG. 3 depicts a wind turbine blade with a stability component;

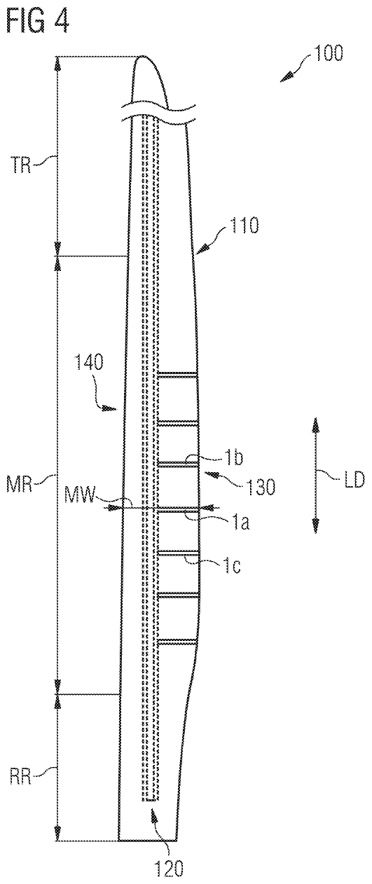

FIG. 4 depicts a wind turbine blade with several stability components;

FIG. 5 depicts a manufacturing method; and

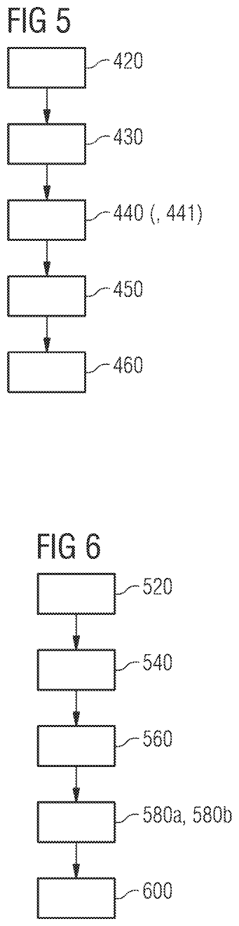

FIG. 6 depicts a manufacturing method.

### DETAILED DESCRIPTION

FIG. 1 and FIG. 2 show in a cross-section view a wind turbine blade 100 for a wind turbine, wherein the wind turbine blade 100 is extending in a longitudinal direction LD from a root region RR comprising a root attachment interface for attaching the wind turbine blade 100 to a rotor of the wind turbine, through a middle region MR comprising a maximum chordal width MW of the wind turbine blade 100, into a tip region TR comprising a wind turbine blade tip (see e.g., FIG. 4). The wind turbine blade 100 comprises a blade shell 110, the blade shell 110 surrounding an inner space I of the wind turbine blade 100. Furthermore, the wind turbine blade 100 comprises a main beam 120, in particular a single main beam, running in the longitudinal direction LD of the wind turbine blade 100 (see e.g., FIG. 4) with two opposite arranged spar caps 121, 122 and a web 123 connecting the two spar caps 121, 122. Furthermore, the wind turbine blade 100 comprises at least a stability component 1a wherein the stability component 1a is configured according to a first aspect of embodiments of the invention. The first sub-body 10 of the stability component 1a and/or the second sub-body 20 of the stability component 1a is formed plate-like, and wherein at least the first sub-body 10 is arrangeable (see FIG. 1) or arranged (see FIG. 2) with an arrangement section 11 on a counter arrangement section 21 of the second sub-body 20 to increase the stability of the stability component 1a. The first sub-body 10 of the stability component 1a is arranged by a component interface 9 of the stability component 1a in the inner space I of the wind turbine blade 100 angled to the longitudinal direction LD of the wind turbine blade 100 for stabilizing the blade shell 110 of the wind turbine blade 100 of the wind turbine (see e.g., FIG. 4). It is conceivable that the first sub-body 10 of the stability component is integrally formed with the blade shell 110 of the wind turbine blade 100. The component interface 9 of the first sub-body 10 of the stability component 1a is built circumferentially at an edge section of the first sub-body 10 of the stability component 1a. Furthermore, the first sub-body of the stability component 1a is arranged on the main beam 120 and the blade shell 110, and wherein the first sub-body 10 extends respectively the first sub-body 10 together with the second sub-body 20 (see FIG. 2) are extending from the main beam 120 to a trailing edge 130 of the wind turbine blade 100 in the inner space I of the wind turbine blade 100. Advantageously, with such a stability component 1a, a trailing-edge beam can be dispensed with.

It is further conceivable for the wind turbine blade 100 according to FIG. 1 respectively FIG. 2 that the first sub-body 10 of the stability component 1a is frame-shaped to form a circumferential stabilizing frame, wherein the circumferential stabilizing frame is surrounding a frame opening O. Alternatively, it is conceivable (not shown) that the stability component 1a comprises a stabilizing frame, in particular a circumferential stabilizing frame, wherein the first sub-body 10 is forming together with the second sub-body 20 at least a part of the stabilizing frame, wherein the stabilizing frame is surrounding a frame opening O.

It is further conceivable for the wind turbine blade 100 according to FIG. 1 respectively FIG. 2 that the second sub-body 20 can be arranged or is arranged with the counter arrangement section 21 on the arrangement section 11 of the first sub-body 10 in such a way that the frame opening O is at least partially covered by the second sub-body 20 in order to increase a stability of the stability component 1a (see FIG. 2).

It is further conceivable for the wind turbine blade 100 according to FIG. 1 respectively FIG. 2 that the first sub-body 10 and/or the second sub-body 20 comprise a plate-shaped core-body having a first plate side and a second plate side opposite the first plate side, and that the first sub-body 10 and/or the second sub-body 20 comprise a first cover-body for absorbing forces to stabilize the blade shell 110 of the wind turbine blade 100, wherein the first cover-body is arranged on the first plate side of the core-body, and that the first sub-body 10 and/or the second sub-body 20 comprise a second cover-body for absorbing forces to stabilize the blade shell 110 of the wind turbine blade 100, wherein the second cover-body is arranged on the second plate side of the core-body. In other words, the first sub-body 10 and/or the second sub-body 20 can be a sandwich-body.

FIG. 3 shows in a cross-section view a wind turbine blade 100 as especially already described with regard to FIG. 1 respectively FIG. 2, wherein the stability component 1a is a one-piece stability component and not multi-part as shown in FIG. 1 or FIG. 2. In embodiments, the stability component 1a is plate-shaped and comprises a core-body having a first plate side and a second plate side opposite the first plate side, wherein a first cover-body, e.g., fiber plies, is arranged on the first plate side of the core-body and a second cover-body, e.g., fiber plies, is arranged on the second plate side of the core-body. In other words, the stability component 1a can form a sandwich-body. Advantageously, with such a stability component 1a, a trailing-edge beam can be dispensed with and at the same time, there is no need to also incorporate a stability component extending from the main beam 120 to a leading edge 140 (that is opposite to the trailing edge 130) of the wind turbine blade 100.

FIG. 4 shows in a top view a wind turbine blade 100 as especially already described with regard to FIG. 1 and/or FIG. 2 and/or FIG. 3. The wind turbine blade 100 comprises multiple stability components 1a, 1b, 1c. Each of the multiple stability components 1a, 1b, 1c is arranged in the inner space I of the wind turbine blade 100 at an angle of 90° or substantially 90° with regard to the longitudinal direction LD of the wind turbine blade 100. Alternatively, it is also conceivable that at least one stability component 1a, 1b, 1c of the multiple stability components 1a, 1b, 1c is arranged in the inner space I of the wind turbine blade 100 at an angle of 45°-85°, in particular at an angle of 60°-80°, with regard to the longitudinal direction LD of the wind turbine blade 100. Furthermore, the three or more stability components 1a, 1b, 1c are spaced apart, for example evenly spaced apart, from each other, wherein especially one stability component 1a is placed at the position of the maximum chordal width MW of the wind turbine blade 100 or close to it.

FIG. 5 shows a method of manufacturing a wind turbine blade 100 for a wind turbine, wherein in particular, the wind turbine blade 100 is configured according to embodiments of the invention, for example, as described with regard to FIGS. 1-4. In embodiments, the method comprises as a step that several or multiple blade shell members of a blade shell 110 of the wind turbine blade 100 are provided 420. Furthermore, in embodiments the method comprises as a step that at least a stability component 1a is provided 430, wherein the stability component 1a is configured according to embodiments of the invention. Furthermore, in embodiments the method comprises as a step that the at least one stability component 1a is arranged 440 or arranged 440 and joined 441 to at least a first blade shell member of the several or the plurality of blade shell members. Furthermore, in embodiments the method comprises as a step that the remaining blade shell members of the several or the plurality of blade shell members are arranged 450 to the first blade shell member and to the stability component 1a, which is arranged or arranged and joined to the first blade shell member. Furthermore, in embodiments the method comprises as a step that at least the several or the plurality of blade shell members and the at least one stability component 1a are joined together.

FIG. 6 shows a further method of manufacturing a wind turbine blade 100 for a wind turbine, wherein at least a blade shell 110 of the wind turbine blade 100 is integrally manufactured, wherein in particular the wind turbine blade 100 is configured according to embodiments of the invention, for example, as described with regard to FIGS. 1-4. In embodiments, the method comprises as a step that at least a stability component 1a is provided 520, wherein the stability component 1a is configured according to embodiments of the invention, especially according to a first aspect of embodiments of the invention. Furthermore, in embodiments, the method comprises as a step that components, e.g., balsa wood, fiber plies, molds, etc., to integrally form the blade shell 110 of the wind turbine blade 100, e.g., by a vacuum infusion process, are provided and arranged 540, wherein the arranged components are arranged in such a way, e.g., by the help of mandrels, that they are forming an inner space I. Furthermore, in embodiments the method comprises as a step that at least the first sub-body 10 of the stability component 1a is arranged in the created inner space I formed by the arranged components. Furthermore, in embodiments the method comprises as a step that the first sub-body 10, e.g., a frame-shaped first sub-body 10, of the stability component 1a is joined 580a to the (arranged) components (for integrally forming the blade shell 110). Furthermore, in embodiments the method comprises as a step that at least the components to form the integrally manufactured blade shell 110 are joined 580b, e.g., by a vacuum infusion process. Furthermore, in embodiments the method comprises as a step that the second sub-body 20 is arranged 600 with the counter arrangement section 21 to the arrangement section 11 of the first sub-body 10 to increase a stability of the stability component 1a, wherein especially the second sub-body 20 is arranged 600 to the first sub-body 10 temporally after joining 580b, in particular non-detachably joining, the components to form the integrally manufactured blade shell 110.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A stability component, wherein the stability component is configured to be arranged in an inner space of a wind turbine blade angled to a longitudinal direction of the wind turbine blade by a component interface of the stability component for stabilizing a blade shell of the wind turbine blade of a wind turbine, wherein the component interface of the stability component is built at least partially on an edge section of the stability component, wherein the stability component is multi-part with at least a first sub-body and a second sub-body, wherein the first sub-body and/or the second sub-body is formed plate-like, and wherein at least the first sub-body is arrangeable or arranged with an arrangement section on a counter arrangement section of the second sub-body to increase the stability of the stability component.

2. The stability component according to claim 1, wherein the first sub-body of the stability component is frame-shaped to form a circumferential stabilizing frame, wherein the circumferential stabilizing frame is surrounding a frame opening.

3. The stability component according to claim 2, wherein the second sub-body can be arranged or is arranged with the counter arrangement section on the arrangement section of the first sub-body in such a way that the frame opening is at least partially covered by the second sub-body in order to increase a stability of the stability component.

4. The stability component according to claim 1, wherein the stability component comprises a stabilizing frame, a circumferential stabilizing frame, wherein the first sub-body is forming together with the second sub-body at least a part of the stabilizing frame, wherein the stabilizing frame is surrounding a frame opening.

5. The stability component according to claim 1, wherein the first sub-body with the arrangement section is arranged detachably, non-destructively detachably, on the counter arrangement section of the second sub-body.

6. The stability component according to claim 1, wherein the first sub-body and/or the second sub-body comprises:
a plate-shaped core-body having a first plate side and a second plate side opposite the first plate side,
a first cover-body for absorbing forces to stabilize the blade shell of the wind turbine blade,
wherein the first cover-body is arranged on the first plate side of the core-body,
a second cover-body for absorbing forces to stabilize the blade shell of the wind turbine blade, wherein the second cover-body is arranged on the second plate side of the core-body.

7. A method comprising utilizing at least a first stability component for stabilizing a blade shell of a wind turbine blade of a wind turbine by arranging the at least one first stability component in an inner space of the wind turbine blade angled to a longitudinal direction of the wind turbine blade at least in a middle region of the wind turbine blade by a component interface of the at least one first stability component, wherein the at least one first stability component is plate-shaped, and wherein the at least one first stability component comprises:
a plate-shaped core-body having a first plate side and a second plate side opposite the first plate side,
a first cover-body for absorbing forces to stabilize the blade shell of the wind turbine blade,
wherein the first cover-body is arranged on the first plate side of the core-body,
a second cover-body for absorbing forces to stabilize the blade shell of the wind turbine blade, wherein the second cover-body is arranged on the second plate side of the core-body.

8. The method comprising utilizing the at least one first stability component according to claim 7, wherein the wind turbine blade comprises a main beam, a single main beam, extending in the longitudinal direction of the wind turbine blade with two opposite arranged spar caps and a web connecting the two spar caps, wherein the at least one first stability component is at least partially arranged on the main beam and the blade shell, and wherein the at least one first stability component extends from the main beam in a direction towards a trailing edge of the wind turbine blade in the inner space of the wind turbine blade.

9. The method comprising utilizing the at least one first stability component according to claim 7, wherein the at least one first stability component is arranged in the inner space of the wind turbine blade at an angle of 90° or substantially 90° with regard to the longitudinal direction of the wind turbine blade
or
that the at least one first stability component is arranged in the inner space of the wind turbine blade at an angle of 45°-85°, at an angle of 60°-80°, with regard to the longitudinal direction of the wind turbine blade.

10. The method comprising utilizing the at least one first stability component according to claim 7, wherein at least one second plate-shaped stability component is arranged in the inner space of the wind turbine blade angled to the longitudinal direction of the wind turbine blade in the middle region of the wind turbine blade by a component interface of the second stability component for stabilizing the blade shell of the wind turbine blade of the wind turbine, wherein the at least one first stability component is spaced apart from the at least one second stability component in the longitudinal direction of the wind turbine blade.

11. The method comprising utilizing the at least one first stability component according to claim 7, wherein at least the at least one first stability component and/or the at least one second stability component is configured to be arranged in an inner space of a wind turbine blade angled to a longitudinal direction of the wind turbine blade by a component interface of the stability component for stabilizing a blade shell of the wind turbine blade of a wind turbine, wherein the component interface of the stability component is built at least partially on an edge section of the stability component, wherein the stability component is multi-part with at least a first sub-body and a second sub-body, wherein the first sub-body and/or the second sub-body is formed plate-like, and wherein at least the first sub-body is arrangeable or arranged with an arrangement section on a counter arrangement section of the second sub-body to increase the stability of the stability component.

12. A wind turbine blade for a wind turbine, wherein the wind turbine blade is extending in a longitudinal direction from a root region comprising a root attachment interface for attaching the wind turbine blade to a rotor of the wind turbine, through a middle region comprising a maximum chordal width of the wind turbine blade, into a tip region comprising a wind turbine blade tip, and wherein the wind turbine blade comprises:
a blade shell, the blade shell surrounding an inner space of the wind turbine blade,
a main beam, a single main beam, running in the longitudinal direction of the wind turbine blade with two opposite arranged spar caps and a web connecting the two spar caps,
at least a stability component, wherein the stability component is configured according to claim 1, wherein the stability component is arranged by a component interface of the stability component in the inner space of the wind turbine blade angled to the longitudinal direction of the wind turbine blade for stabilizing the blade shell of the wind turbine blade of the wind turbine, wherein the component interface of the stability component is built at least partially on an edge section of the stability component and wherein especially the stability component is at least partially arranged on the main beam and/or the blade shell, and
wherein the stability component extends from the main beam in a direction towards a trailing edge of the wind turbine blade in the inner space of the wind turbine blade.

13. The wind turbine blade according to claim 12, wherein at least several or a plurality of stability components are arranged by a respective component interface in the middle region in the inner space of the wind turbine blade each angled to the longitudinal direction of the wind turbine blade for stabilizing the blade shell of the wind turbine blade of the wind turbine, wherein the several or the plurality of stability components are arranged spaced apart from each other in the longitudinal direction of the wind turbine blade.

14. A method of manufacturing a wind turbine blade for a wind turbine, wherein the wind turbine blade is configured according to claim 12, the method comprising:
providing several or multiple blade shell members of a blade shell of the wind turbine blade,
providing the stability component,
arranging or arranging and joining the at least one stability component to at least a first blade shell member of the several or the plurality of blade shell members,
arranging the remaining blade shell members of the several or the plurality of blade shell members to the first blade shell member and to the stability component, which is arranged or arranged and joined to the first blade shell member,
joining, non-detachably joining, at least the several or the plurality of blade shell members and the at least one stability component.

15. The method of manufacturing a wind turbine blade for a wind turbine, wherein at least a blade shell of the wind turbine blade is integrally manufactured, wherein the wind turbine blade is configured according to claim 12, the method comprising:
providing the stability component, arranging components to integrally form the blade shell of the wind turbine blade, wherein the arranged components are forming an inner space,
arranging at least the first sub-body of the stability component in the inner space formed by the arranged components,
joining the first sub-body of the stability component to the components,
joining, non-detachably joining, at least the components to form the integrally manufactured blade shell,
arranging the second sub-body with the counter arrangement section to the arrangement section of the first sub-body to increase a stability of the stability component, wherein especially the second sub-body is arranged to the first sub-body temporally after joining, non-detachably joining, the components to form the integrally manufactured blade shell.
